(19) United States
(12) Patent Application Publication
(10) Pub. No.: US 2007/0152912 A1
(43) Pub. Date: Jul. 5, 2007

(54) Plasma display panel without transparent electrodes

(76) Inventors: Hyun Soh, Suwon-si (KR); Kyoung-Doo Kang, Suwon-si (KR); Se-Jong Kim, Suwon-si (KR); Yun-Hee Kim, Suwon-si (KR); Hyun Kim, Suwon-si (KR); Jin-Won Han, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/640,565

(22) Filed: Dec. 18, 2006

(30) Foreign Application Priority Data
Dec. 30, 2005 (KR) 10-2005-0135856

(51) Int. Cl. G09G 3/28

(52) U.S. Cl. 345/63

(57) ABSTRACT

In order to reduce reactive consumption power and enhance daylight contrast, provided is a plasma display panel including a first substrate and a second substrate that are facing and separated from each other; a plurality of barrier ribs defining a discharge space between the first substrate and the second substrate and forming a plurality of discharge cells; a plurality of X electrodes including a plurality of first extending electrode parts disposed in a stripe pattern on the first substrate, and a plurality of first protruding electrode parts protruding substantially perpendicularly from the first extending electrode parts; a plurality of Y electrodes including a plurality of second extending electrode parts disposed in parallel to the first extending electrode parts of the X electrodes on the first substrate, and a plurality of second protruding electrode parts protruding substantially perpendicularly from the second extending electrode parts, and generating a sustain discharge together with the first protruding electrode parts; a plurality of address electrodes disposed in a stripe pattern on the second substrate and substantially perpendicular to the first extending electrode parts and the second extending electrode parts; and a first dielectric layer formed on the surface of the first substrate to cover the X electrodes and the Y electrodes.

### CROSS-REFERENCE TO RELATED PATENT APPLICATIONS

This application claims the benefit of Korean Patent Application No. 10-2005-0135856, filed on Dec. 30, 2005, in the Korean Intellectual Property Office, the disclosure of which is incorporated herein in its entirety by reference.

### BACKGROUND OF THE INVENTION

1. Field of the Invention

The present embodiments relate to a plasma display panel without transparent electrodes, and more particularly, to a plasma display panel having a bus electrode structure and field concentration parts which are capable of lowering consumption power and enhancing daylight contrast.

2. Description of the Related Art

In plasma display panels, a gas discharge occurs between electrodes due to a DC or AC voltage that is applied to the electrodes, and phosphors are excited by ultraviolet radiation generated during the gas discharge, so that visible light is emitted.

Plasma display panels can be classified into a DC type and an AC type according to a discharge type. In an AC-type plasma display panel, at least one electrode is surrounded to a dielectric layer, and a discharge is performed by wall charges, instead of direct charge movement between corresponding electrodes.

Also, plasma display panels can be classified into a facing discharge type and a surface discharge type according to an arrangement of the electrodes. In a facing discharge type plasma display panel, a pair of sustain electrodes are disposed on an upper substrate and a lower substrate, respectively, so that a discharge occurs substantially perpendicular to the upper and lower substrates. In a surface discharge type plasma display panel, a pair of sustain electrodes are disposed on the same substrate, so that a discharge occurs parallel to the substrate.

A conventional AC 3-electrode type plasma display panel includes a front panel and a rear panel, wherein the front panel includes X electrodes and Y electrodes, each consisting of a transparent electrode and a bus electrode, and a front dielectric layer, and the rear panel includes address electrodes, a rear dielectric layer, barrier ribs, and phosphor layers.

However, since a process of forming transparent electrodes must be performed separately from a process of forming bus electrodes when the conventional plasma display panel is manufactured, manufacturing costs and time increase. Korean Patent Publication No. 0366101 discloses an Indium-Tin-Oxide (ITO)-less plasma display panel in which X and Y electrodes are formed only with bus electrodes, but not with transparent electrodes, and requiring high costs.

Also, in order to reduce a discharge start voltage and improve visible light transmittance in the conventional AC 3-electrode type plasma display panel, Korean Patent Publication No. 0322071 discloses a plasma display panel in which a field concentration part is formed in the shape of a groove in a front dielectric layer.

However, since opaque bus electrodes are disposed over discharge spaces, visible light transmittance is low, and separate black stripes must be formed on barrier ribs in order to reduce reflection brightness of external light. Also, since ultraviolet generation efficiency by a plasma discharge is very low, a high driving voltage must be applied to the conventional AC 3-electrode type plasma display panel. Accordingly, there is a need for a display with lower consumption power.

### SUMMARY OF THE INVENTION

The present embodiments provide a plasma display panel which includes field concentration parts formed in parts of a dielectric layer corresponding to discharge cells, and bus electrodes protruding from vertical barrier rib parts and used together with adjacent discharge cells without transparent electrodes, thereby lowering reactive consumption power and enhancing daylight contrast.

According to an aspect of the present embodiments, there is provided a plasma display panel including: a first substrate and a second substrate that are facing and separated from each other; a plurality of barrier ribs defining a discharge space between the first substrate and the second substrate and forming a plurality of discharge cells; a plurality of X electrodes including a plurality of first extending electrode parts located in a stripe pattern on the first substrate, and a plurality of first protruding electrode parts protruding substantially perpendicularly from the first extending electrode parts; a plurality of Y electrodes including a plurality of second extending electrode parts disposed in parallel to the first extending electrode parts of the X electrodes on the first substrate, and a plurality of second protruding electrode parts protruding substantially perpendicularly from the second extending electrode parts, and generating a sustain discharge together with the first protruding electrode parts; a plurality of address electrodes disposed in a stripe pattern on the second substrate and substantially perpendicular to the first extending electrode parts and the second extending electrode parts; and a first dielectric layer formed on the surface of the first substrate to cover the X electrodes and the Y electrodes.

The plurality of barrier ribs include a plurality of horizontal barrier ribs substantially parallel to the first extending electrode and a plurality of vertical barrier ribs, the first protruding electrode parts of the X electrodes and the second protruding electrode parts of the Y electrodes are alternately disposed on vertical barrier ribs, and at least one portion of the first protruding electrode parts is facing at least one portion of the second protruding electrode parts.

According to the construction, it is possible to reduce external reflection brightness, enhance daylight contrast, increase an opening ratio, enhance transmittance of visible light, and increase luminous efficiency.

The first dielectric layer includes a plurality of field concentration parts in a groove shape. The plurality of field concentration parts are separately formed so that the respective field concentration parts are arranged to correspond to the discharge spaces of the discharge cells. The field concentration parts are continuously formed between the pairs of first extending electrode parts of the X electrodes and the second extending electrode parts of the Y electrodes so that the field concentration parts are extended across the discharge spaces of the discharge cells. According to the construction, it is possible to lower a discharge start voltage and thus reduce consumption power.

A cross-section of each of the field concentration parts is in the form of a rectangle when viewing in a direction substantially perpendicular to the first substrate and the first extending electrode parts. A cross-section of each of the field concentration parts is in the form of a trapezoid when viewing in a direction substantially perpendicular to the first substrate and the first extending electrode parts.

### BRIEF DESCRIPTION OF THE DRAWINGS

The above and other features and advantages of the present embodiments will become more apparent by describing in detail exemplary embodiments thereof with reference to the attached drawings in which:

FIG. 1 illustrates a partially sectioned perspective view of a plasma display panel according to an embodiment;

FIG. 2 illustrates a structure of bus electrodes of the plasma display panel according to the embodiment;

FIG. 3 is a cross-sectional view of the plasma display panel along line III-III as illustrated in FIG. 1, according to the embodiment;

FIG. 4 illustrates a cross-sectional view of a plasma display panel according to another embodiment;

FIG. 5 is a cross-sectional view of a plasma display panel according to another embodiment;

FIG. 6 illustrates a structure in which field concentration parts of the plasma display panel illustrated in FIG. 4 are separately formed so that the respective field concentration parts are arranged to correspond to respective discharge cells, according to an embodiment; and

FIG. 7 illustrates a structure in which a field concentration part of the plasma display panel illustrated in FIG. 4 is continuously formed, according to an embodiment.

### DETAILED DESCRIPTION OF THE INVENTION

The present embodiments will now be described more fully with reference to the accompanying drawings, in which exemplary embodiments are shown.

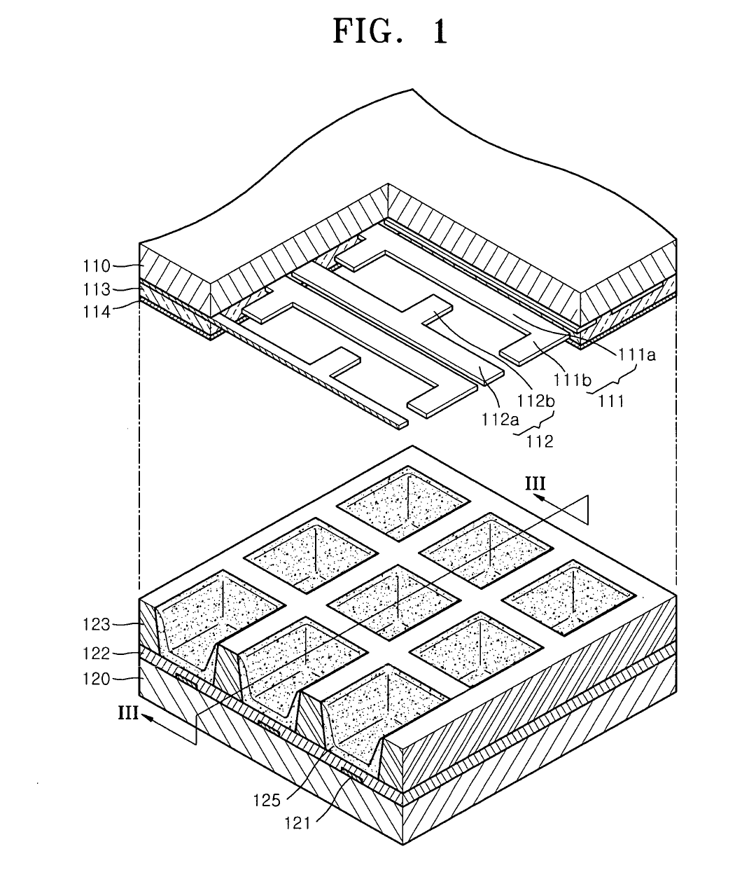

FIG. 1 illustrates a partially sectioned perspective view of a plasma display panel according to an embodiment.

Referring to FIG. 1, a front panel includes a first substrate 110, a plurality of bus electrode pairs 111 and 112 formed below the first substrate 110 and intersecting a plurality of address electrodes 121 of a rear panel, a first dielectric layer 113 formed to cover the bus electrode pairs 111 and 112, and a protective layer 114 formed on the first dielectric layer 113.

The rear panel includes a second substrate 120, the plurality of address electrodes 121 formed in parallel on the second substrate 120, a second dielectric layer 122 covering the address electrodes 121, barrier ribs 123 defining discharge spaces in order to form discharge cells and prevent electrical and optical interference from occurring between the discharge cells, and phosphor layers 125 that are formed in the discharge cells and convert and emit ultraviolet light emitted when an excited discharge gas stabilizes into visible light of Red (R), Green (G), and Blue (B).

The first substrate 110 and the second substrate 120 are separated in parallel by a predetermined distance from each other, so that discharge spaces are formed therebetween. In one embodiment, the first substrate 110 of the front panel is formed of a transparent glass material in order to transmit visible light. However, the present embodiments are not limited thereto. The first substrate 110 can be made of a transparent material or both the first and second substrates 110 and 120 can be made of a transparent material. Accordingly, the present embodiments include a transmittance type plasma display panel, as well as a reflection type plasma display panel in which visible light is generated when vacuum ultraviolet light (VUV) emitted from an excited discharge gas hits the phosphor layers 125 is reflected in an opposite direction, as illustrated in FIG. 1,

The barrier ribs 123 of the rear panel define the discharge cells by partitioning a space between the first substrate 110 and the second substrate 120 so that a basic unit of an image is formed, and prevents crosstalk between the discharge cells.

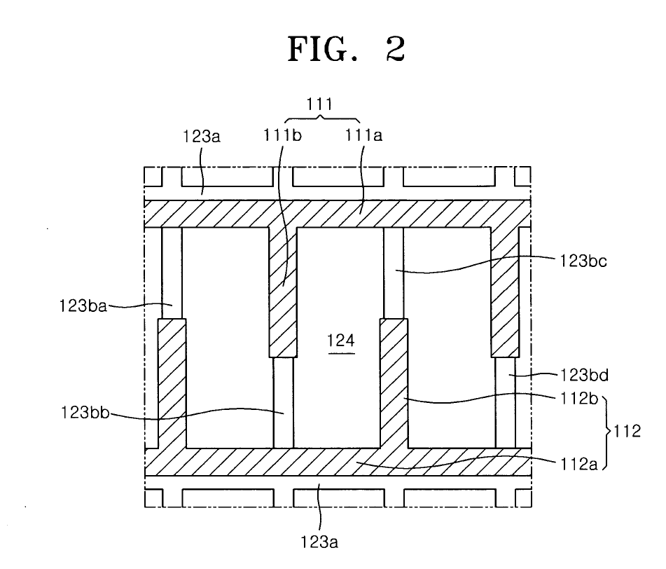

FIG. 2 illustrates a structure of bus electrodes of a plasma display panel, according to an embodiment. Referring to FIG. 2, a pair of bus electrodes consists of an X electrode 111 and a Y electrode 112 which generate a sustain discharge. The X electrode 111 includes a plurality of first extending electrode parts 111a that are formed in a stripe pattern on the first substrate 110, and a plurality of first protruding electrode parts 111b that protrude from the first extending electrode parts 111a, and are substantially perpendicular to the first extending electrode parts 111a. The Y electrode 112 includes a plurality of second extending electrode parts 112a in parallel to the first extending electrode parts 111a of the X electrode 111 on the first substrate 110, and a plurality of second protruding electrode parts 112b that protrude from the second extending electrodes parts 112a, are substantially perpendicular to the second extending electrode parts 112a, and generate a sustain discharge together with the first protruding electrode parts 111a.

Also, the first extending electrode parts 111a of the X electrode 111 are parallel to the second extending electrode parts 112a of the Y electrode 112, and discharge cells 124 are formed between the first extending electrode parts 111a and the second extending electrode parts 112a of the X electrode 111 and the Y electrode 112, respectively.

The first and second extending electrode parts 111a and 112a can be disposed respectively on neighboring horizontal barrier ribs 123a defining the discharge cell 124, or can be located in discharge spaces. Also, the first protruding electrode parts 111b of the X electrode 111 and the second protruding electrode parts 112b of the Y electrode 112 are alternately disposed on vertical barrier ribs 123bb and 123bc such that a part of the first protruding electrode 111b is facing a part of an adjacent second protruding electrode 112b.

If three discharge cells 124 as illustrated in FIG. 2 are defined as an R cell, a G cell, and a B cell from left to right, the second protruding electrode part 112b of the Y electrode 112 is located on a vertical barrier rib 123ba of the R cell, the first protruding electrode part 111b of the X electrode 111 is located on the vertical barrier rib 123bb of the R cell, and the first protruding electrode 112b of the Y electrode 112 is located on the Y electrode on the vertical barrier rib 123bc of the G cell.

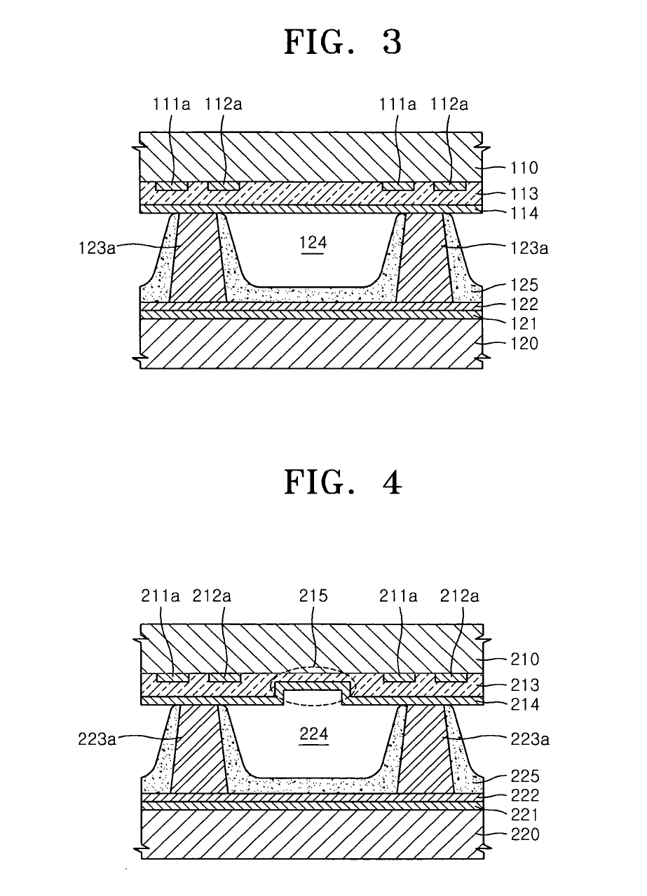

FIG. 3 is a cross-sectional view of the plasma display panel along line III-III as illustrated in FIG. 1, according to an embodiment.

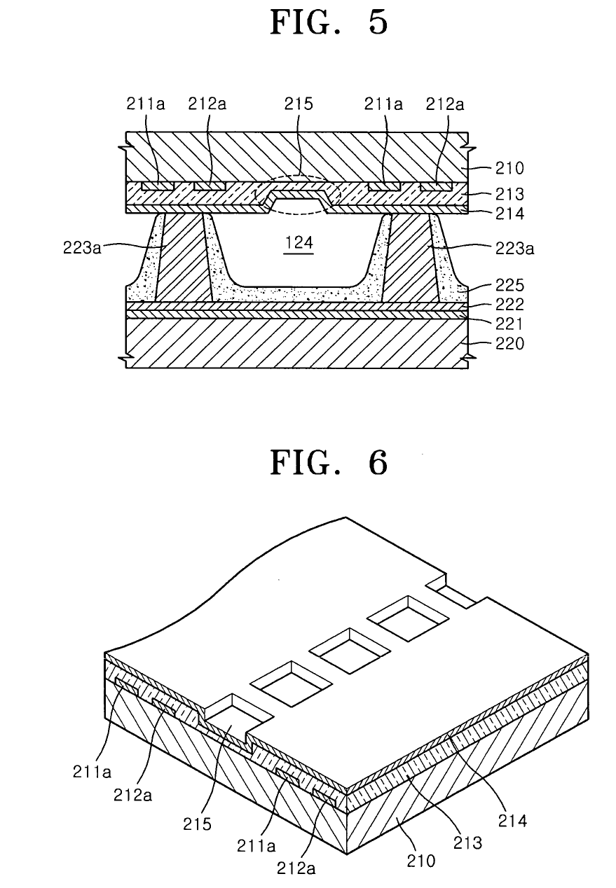

Referring to FIGS. 1 and 3, the first dielectric layer 113 covers the bus electrode pairs 111 and 112 on the first substrate 110 and is used as an insulation film. The first dielectric layer 113 is formed of a material having high insulation resistance and good light transmittance. FIG. 4 illustrates a cross-sectional view of a plasma display panel according to another embodiment, FIG. 5 is a cross-sectional view of a plasma display panel according to another embodiment, and FIG. 6 illustrates a structure in which field concentration parts of the plasma display panel illustrated in FIG. 4 are separately formed so that the respective field concentration parts are arranged to correspond to respective discharge cells, according to an embodiment. Referring to FIG. 4, a plurality of field concentration parts 215 are formed in a part corresponding to a discharge space of a discharge cell 224 between bus electrode pairs 211a and 212a. The field concentration part 215 is formed in the shape of a groove. The cross-section of the field concentration part 215 is sectioned in a direction substantially perpendicular to first extending electrode parts 211a of an X electrode of a first substrate 210, and may be a rectangle as illustrated in FIG. 4, or may be a trapezoid as illustrated in FIG. 5.

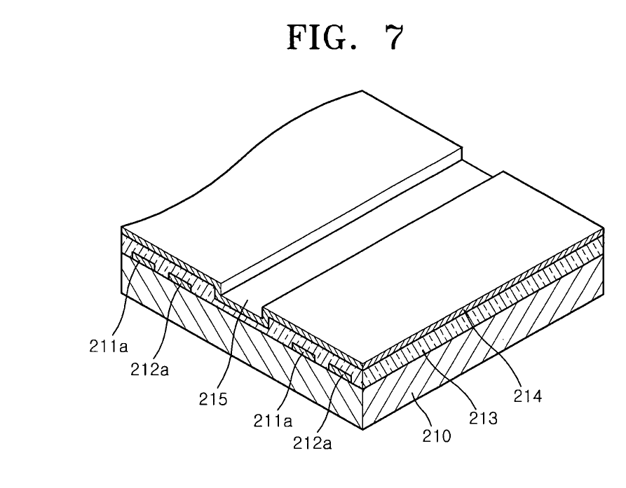

As illustrated in FIG. 6, the field concentration parts 215 can be separately formed so that the respective field concentration parts are arranged to correspond to discharge spaces of the discharge cells 224 (see FIG. 4). That is, the field concentration parts 215 corresponding to the number of the discharge cells 224 can be formed. FIG. 7 illustrates a structure in which a field concentration part of the plasma display panel illustrated in FIG. 4 is continuously formed, according to an embodiment.

As illustrated in FIG. 7, the field concentration part 215 can be continuously formed in the shape of a groove between the pairs of first extending electrode parts 211a of the X electrode and second extending electrode parts 211b of a Y electrode.

Because of the groove of the field concentration part 215, a discharge path between the X electrode and the Y electrode is shortened, and the sustain discharge between the X electrode and the Y electrode is facilitated. Also, because the electric field in the groove is intensified, density of electrons (negative charge) and ions (positive charge) in the groove is increased, and the sustain discharge between the X electrode and the Y electrode is facilitated. Also, because the groove of the field concentration part 215 facilitates the sustain discharge between the X electrode and the Y electrode, the X electrode and Y electrode can be disposed from each other further and the discharge space can be large, hence luminous efficiency can be increased.

Referring to FIGS. 1 and 4, the protective layer 114 or a protective layer 214 is formed to protect the first dielectric layer 113 or a first dielectric layer 213 and accelerates the emitting of secondary electrons when a discharge occurs, facilitating the discharge. The protective layer 114 or 214 is formed of a material, such as magnesium oxide, etc. The second dielectric layer 122 or a second dielectric layer 222 is formed to cover the address electrodes 121 or address electrodes 221 and is used as an insulation film of the address electrodes 121 or 221. Accordingly, the second dielectric layer 122 or 222 is formed of a material having high insulation resistance.

Phosphor layers 125 or 225 are formed on the second dielectric layer 122 or 222 and the internal walls of the discharge cells 124 or 224 (see FIGS. 4 and 5) are defined by the barrier ribs 123 or barrier ribs 223a. In the phosphor layers 125 or 225, a photo luminescence phenomenon occurs, in which visible light is emitted when electrons excited due to the absorption of vacuum ultraviolet light that is generated by a discharge again return to a stable state. Also, in the phosphor layers 125 or 225, a red phosphor layer, a green phosphor layer, and a blue phosphor layer are disposed in the discharge cells 124 or 224 to form a unit pixel, so that the plasma display panel can display a color image. Any suitable discharge gas, such as Ne gas, He gas, He gas, Ar gas or a mixed gas such as Xe gas and at least one of Ne gas, He gas, or Ar gas can be used as a discharge gas.

Hereinafter, though not wishing to be limited by this theory, the function and effects of a plasma display panel according to an embodiment will be described.

An image signal received from the outside is input to an image processor (not shown) and a logic controller (not shown) and is converted into a signal in order to output a desired image, so that a predetermined voltage is applied to the X electrodes 111 or 211, the Y electrodes 112 or 212, and the address electrodes 121 or 221. Then, a reset period occurs for removing the wall charges of the discharge cells 124 or 224, and then an addressing period for forming wall charges in specific discharge cells in order to select specific discharge cells for creating an image occurs.

Thereafter, if a sustain pulse is alternately applied by a predetermined time to the X electrodes 111 or 211 and the Y electrodes 112 or 212 of the discharge cells 124, a sustain discharge is generated between the first protruding electrode parts 111b or 211b of the X electrode 111 and the second protruding electrode parts 112b or 212b of the Y electrode 112.

In certain embodiments, because of the groove of the field concentration part 215, a discharge path between the X electrode and the Y electrode is shortened, the sustain discharge between the X electrode and the Y electrode is facilitated. Also, because electric field in the groove is intensified, the density of electrons (negative charge) and ions (positive charge) in the groove is increased, the sustain discharge between the X electrode and the Y electrode is facilitated. Also, because the groove of the field concentration part 215 facilitates the sustain discharge between the X electrode and the Y electrode, the X electrode and Y electrode can be disposed from each other further and the discharge space can be large, hence luminous efficiency can be increased.

Since the bus electrodes pairs 111, 112, 211, or 212 having high conductivity are used without transparent electrodes, it is possible to reduce a discharge delay time, manufacturing costs and time.

Also, since the first protruding electrode parts 111b or 211b of the X electrode 111 and the second protruding electrode parts 112b or 212b of the Y electrode 112 operate together between two adjacent discharge cells, it is possible to reduce reactive power consumption of the plasma display panel. Furthermore, since the first extending electrode parts 111a or 211a of the X electrode 111 and the second extending electrode parts 112a or 212a of the Y electrode 112 are located on the vertical barrier rib 123 or a vertical barrier rib 223 of an R cell, a G cell, and a B cell, an opening ratio increases and transmittance of visible light increases, resulting in the enhancement of light emitting efficiency. Also, a haze phenomenon in which light is scattered and emerged from discharge spaces is reduced, which enhances the quality of the plasma display panel. Since bus electrode pairs 111, 112, 211, or 212 are located on the barrier ribs 123, the horizontal barrier ribs 123a or barrier ribs 223a, reflection brightness of external light is reduced and daylight contrast is enhanced.

Furthermore, if the first extending electrode parts 111a or 211a of the X electrode 111 and the second extending electrode parts 112a or 212a of the Y electrode 112 are located on the vertical barrier ribs 123 or 223, an opening rate can increase, transmittance of visible light can increase, light-emitting efficiency can increase, the haze phenomenon of the panel can be reduced, and daylight contrast can be enhanced.

As described above, in a plasma display panel without transparent electrodes, according to the present embodiments, field concentration parts are formed in parts of a dielectric layer corresponding to discharge cells, and protruded bus electrodes that are to be used together with adjacent discharge cells are formed on vertical barrier ribs.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a first substrate and a second substrate facing each other and separated from each other;
a plurality of barrier ribs defining a discharge space between the first substrate and the second substrate and forming a plurality of discharge cells;
a plurality of first electrodes including a plurality of first extending electrode parts located in a stripe pattern on the first substrate, and a plurality of first protruding electrode parts protruding substantially perpendicularly from the first extending electrode parts;
a plurality of second electrodes including a plurality of second extending electrode parts disposed in parallel to the first extending electrode parts on the first substrate, and a plurality of second protruding electrode parts protruding substantially perpendicularly from the second extending electrode parts, and generating a sustain discharge together with the first protruding electrode parts;
a plurality of address electrodes disposed in a stripe pattern on the second substrate and substantially perpendicular to the first extending electrode parts and the second extending electrode parts; and
a first dielectric layer formed on the surface of the first substrate covering the first electrodes and the second electrodes.

2. The plasma display panel of claim 1, wherein the plurality of barrier ribs comprise a plurality of horizontal barrier ribs substantially parallel to the first extending electrode and a plurality of vertical barrier ribs, wherein the first protruding electrode parts and the second protruding electrode parts are alternately disposed on vertical barrier ribs, and wherein at least one portion of the first protruding electrode parts is facing at least one portion of the second protruding electrode parts.

3. The plasma display panel of claim 2, wherein the at least one portion of the first extending electrode parts and the at least one portion of the second extending electrode parts are respectively disposed on adjacent horizontal barrier ribs forming a discharge cell such that the at least one portion of the first protruding electrode parts is facing the at least one portion of the second protruding electrode parts.

4. The plasma display panel of claim 1, wherein the first dielectric layer includes a plurality of field concentration parts in a groove shape.

5. The plasma display panel of claim 4, wherein the plurality of field concentration parts are separately formed so that the respective field concentration parts are arranged to correspond to the discharge spaces of the discharge cells.

6. The plasma display panel of claim 4, wherein the field concentration parts are continuously formed between the pairs of first extending electrode parts and the second extending electrode parts so that the field concentration parts are extended across the discharge spaces of the discharge cells.

7. The plasma display panel of claim 4, wherein a cross-section of each of the field concentration parts is in the form of a rectangle when viewing in a direction substantially perpendicular to the first substrate and the first extending electrode parts.

8. The plasma display panel of claim 4, wherein a cross-section of each of the field concentration parts is in the form of a trapezoid when viewing in a direction substantially perpendicular to the first substrate and the first extending electrode parts.

9. The plasma display panel of claim 1, further comprising:
a protective layer formed on the first dielectric layer;
a second dielectric layer formed on the second substrate to cover the address electrodes; and
a plurality of phosphor layers formed on at least one portion of the discharge space.

10. A plasma display panel comprising:
a first substrate and a second substrate facing each other and separated from each other;
a plurality of horizontal barrier ribs and a plurality of vertical barrier ribs, defining a discharge space between the first substrate and the second substrate and forming a plurality of discharge cells;
a plurality of first electrodes including a plurality of first extending electrode parts disposed in a stripe pattern on the first substrate, and a plurality of first protruding electrode parts protruding substantially perpendicularly from the first extending electrode parts;
a plurality of second electrodes including a plurality of second extending electrode parts disposed parallel to the first extending electrode parts on the first substrate, and a plurality of second protruding electrode parts protruding substantially perpendicularly from the second extending electrode parts, and generating a sustain discharge together with the first protruding electrode parts;
a plurality of address electrodes disposed in a stripe pattern on the second substrate and substantially perpendicular to the first extending electrode parts and the second extending electrode parts;
a first dielectric layer formed on the surface of the first substrate covering the first electrodes and the second electrodes and having a plurality of field concentration parts in a groove shape;
a protective layer formed on the first dielectric layer;
a second dielectric layer formed on the second substrate covering the address electrodes; and
a plurality of phosphor layers formed on at least one portion in the discharge space,
wherein the first protruding electrode parts and the second protruding electrode parts are alternately located on vertical barrier ribs such that at least one portion of the first protruding electrode parts is facing at least one portion of the second protruding electrode parts.

11. The plasma display panel of claim 9, wherein the at least one portion of the first extending electrode parts and the at least one portion of the second extending electrode parts are disposed on adjacent horizontal barrier ribs forming a discharge cell such that the at least one portion of the first extending electrode parts is facing the at least one portion of the second extending electrode parts.

12. The plasma display panel of claim 9, wherein the at least one portion of the first extending electrode parts and the at least one portion of the second extending electrode parts are respectively disposed on adjacent horizontal barrier ribs forming a discharge cell such that the at least one portion of the first protruding electrode parts is facing the at least one portion of the second protruding electrode parts.

13. The plasma display panel of claim 9, wherein the plurality of field concentration parts are separately formed so that the respective field concentration parts are arranged to correspond to the discharge spaces of the discharge cells.

14. The plasma display panel of claim 9, wherein the field concentration parts are continuously formed between the pairs of first extending electrode parts and the second extending electrode parts so that the field concentration parts are extended across the discharge spaces of the discharge cells.

15. The plasma display panel of claim 9, wherein a cross-section of each of the field concentration parts is in the form of a rectangle when viewing in a direction substantially perpendicular to the first substrate and the first extending electrode parts.

16. The plasma display panel of claim 9, wherein a cross-section of each of the field concentration parts is in the form of a trapezoid when viewing in a direction substantially perpendicular to the first substrate and the first extending electrode parts.
